(19) United States
(12) Patent Application Publication
(10) Pub. No.: US 2019/0047735 A1
(43) Pub. Date: Feb. 14, 2019

(54) SYSTEM AND METHOD FOR HEAT SEALING FOOD PACKAGING

(71) Applicant: Winpak Portion Packaging, Inc., Sauk Village, IL (US)

(72) Inventors: Kevin M. Callahan, Fairless Hills, PA (US); Steven Patrick Falk, Bolingbrook, IL (US)

(21) Appl. No.: 16/059,773

(22) Filed: Aug. 9, 2018

Related U.S. Application Data
(60) Provisional application No. 62/544,288, filed on Aug. 11, 2017.

(51) Int. Cl. B65B 51/14; B65B 7/16; B29C 65/18; B29C 65/00

(52) U.S. Cl. CPC B65B 51/14; B65B 7/164; B29C 65/18; B29L 2031/712; B29C 66/81261; B29C 66/849; B29C 66/8122

(57) ABSTRACT

The present disclosure is directed to systems and methods for heat sealing plastic packaging. In various embodiments, the disclosure provides a sealing system including a heater block with one or more coupling mechanisms for removable attachment to a silicone shoe. The silicone shoe includes a metal plate coated with or otherwise attached to a mineral-loaded silicone layer, which provides thermal conductivity. The sealing system can be attached to a conventional sealing assembly such that the silicone layer faces a direction toward lids over plastic packages. The silicone layer has a sealing surface which provides heat and pressure to the lids over the plastic packages thereby sealing the lids to the plastic packages. Due to the coupling mechanism, a degraded silicone shoe can be easily detached and replaced with a new silicone shoe.

### CROSS-REFERENCE TO RELATED APPLICATIONS

This application claims priority to U.S. Provisional Patent Application Ser. No. 62/544,288, filed on Aug. 11, 2017 and entitled “System and Method for Heat Sealing Food Packaging,” the entirety of which is incorporated herein by reference.

### BACKGROUND OF THE INVENTION

### 1. Field of the Invention

The present disclosure is directed generally to a system and method for sealing plastic packaging and, more particularly, to a sealing system comprising a silicone shoe removably and magnetically coupled to a heater block.

### 2. Description of Related Art

Plastic containers are filled and sealed with flexible lidding using automated systems. For example, food packaging, such as condiment cups, move in an assembly line fashion from a filling device to a sealing device. Traditional sealing assemblies, such as sealing assembly 1 shown in FIG. 1, use a temperature controlled metallic heater block 2 to provide pressure and heat on a lid 3 over the container. A heater block may include heating elements and temperature control elements for maintaining heat across the heater block to seal plastic containers. Often, the heater block covers the perimeter of the container to provide pressure and heat to a sealing surface, such as a flange around the perimeter of the container. Uniformity of pressure is a concern when there are numerous containers in a tray in an assembly line. To provide an even seal of pressure across the matrix of containers within a tray, a flexible silicone coated fabric pad 4 is loosely draped across a heater block. Such silicone pads can be composed of Teflon reinforced with glass fabric and coated with silicone.

A drawback of a flexible fabric silicone pad is that each layer of the silicone pad is an insulator that restricts the flow of heat and energy to the lidding film of the container. Further, an air-gap is created between the metallic heater blocks and the silicone pad. The air-gap introduces an additional barrier to heat transfer. The barrier to heat transfer requires an increase in temperature and consequently, more energy and work by the sealing assembly. Therefore, current sealing assemblies only achieve a thermal conductivity of less than 0.2 W/m·K.

Current sealing assemblies have other drawbacks as well. As the silicone in the silicone pad is comprised of thermal insulating materials and has an air-gap barrier to heat transfer, the metallic heater block must be heated to a temperature 50 to 100° F. higher than what is required in order to deliver the target temperature to the sealing surface. For example, machine sealing temperatures may need to be set to 600° F. in order to achieve 550° F. at the sealing surface. An increased temperature requires additional energy and power, which increases the degradation rate of the silicone pad and the sealing assembly. Another drawback, which is influenced by the degradation rate of the sealing pad, is that the sealing pads are consumable and require replacement after as little as 8 hours of continuous operation.

### SUMMARY OF THE INVENTION

The present disclosure is directed to systems and methods for sealing plastic packages. In various embodiments, the disclosure provides a sealing system including a heater block with one or more coupling mechanisms, such as high temperature magnets. A silicone shoe is removably attached to the heater block via the one or more coupling mechanisms. The silicone shoe includes a metal plate coated with or otherwise attached to a mineral-filled silicone layer, which provides thermal conductivity. The sealing system can be attached to a conventional sealing assembly such that the silicone layer faces a direction toward flexible lidding over plastic packages. The silicone layer has a sealing surface which transfers heat and pressure to the lidding over the plastic packages thereby sealing the lidding to the plastic packages. Due to the coupling mechanism, a degraded silicone shoe can be easily detached and replaced with a new silicone shoe.

Generally in one aspect, a sealing system is provided. The system includes: a heater block having one or more coupling mechanisms; and a silicone shoe removably attached to the heater block via the coupling mechanism, the silicone shoe having a metal plate bonded with a mineral-loaded silicone layer.

According to an embodiment, the coupling mechanism is a high temperature magnet.

According to an embodiment, the metal plate is magnetically attracted to the high temperature magnet.

According to an embodiment, the coupling mechanisms are centrally located along the bottom surface of the heater block.

According to an embodiment, the silicone layer is a sealing surface.

According to an embodiment, the metal plate is composed of a ferrous metal.

According to an embodiment, one or more tabs extend from an edge of the silicone shoe.

According to an embodiment, the durometer of the mineral-loaded silicone layer is within the range of 40 to 90.

According to an embodiment, a thickness of the mineral-loaded silicone layer is within the range of 0.010 to 0.080 inches.

According to an embodiment, a connector attaches the coupling mechanism to the heat block.

According to an embodiment, the connector extends outward from and beyond the bottom surface of the heater block.

According to an embodiment, the connector extends at least partially into an aperture in the silicone shoe when the heater block is attached to the silicone shoe.

According to an embodiment, the connector is a bolt.

According to an aspect, a method for sealing a container is provided. The method includes the steps of: (i) providing a sealing system having a heater block with at least one coupling mechanism and a silicone shoe removably attached to the heater block via the coupling mechanism, the silicone shoe having a metal plate bonded with a mineral-loaded silicone layer, wherein the mineral-loaded silicone layer is a sealing surface, and wherein the thermal conductivity of the mineral-loaded silicone layer is substantially equal to or greater than 0.25 W/mK; (ii) mounting the heater block to a sealing assembly such that the mineral-loaded silicone layer is positioned above a lid over the container; (iii) heating the mineral-loaded silicone layer; and (iv) forcing the mineral-loaded silicone layer onto the lid over the container; (iv) retracting the mineral-loaded silicone layer from the lid; and (v) removing the silicone shoe from the heater block.

According to an embodiment, the step of (v) removing the silicone shoe from the heater block includes the step of (vi) applying pressure to one or more tabs extending from an edge of the silicone shoe.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the invention will be apparent from and elucidated with reference to the embodiment(s) described hereinafter.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following description taken in conjunction with the accompanying drawings in which:

FIG. 1 shows a perspective view of a silicone pad of a conventional sealing system;

FIG. 2 shows a side schematic representation of a sealing system for heat sealing plastic packaging according to an embodiment;

FIG. 3 shows a perspective view of a heater block of the sealing system according to an embodiment;

FIG. 4 shows a perspective view of the metal plate of the silicone shoe according to an embodiment;

FIG. 5 shows a perspective view of the silicone layer on the metal plate of the silicone shoe according to an embodiment;

FIG. 6 shows a perspective view of the sealing system according to an embodiment;

FIG. 7 shows a perspective view of the sealing system attached to a conventional sealing assembly according to an embodiment; and

FIG. 8 shows a top perspective view of the silicone layer on the metal plate of the silicone shoe according to an alternative embodiment.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

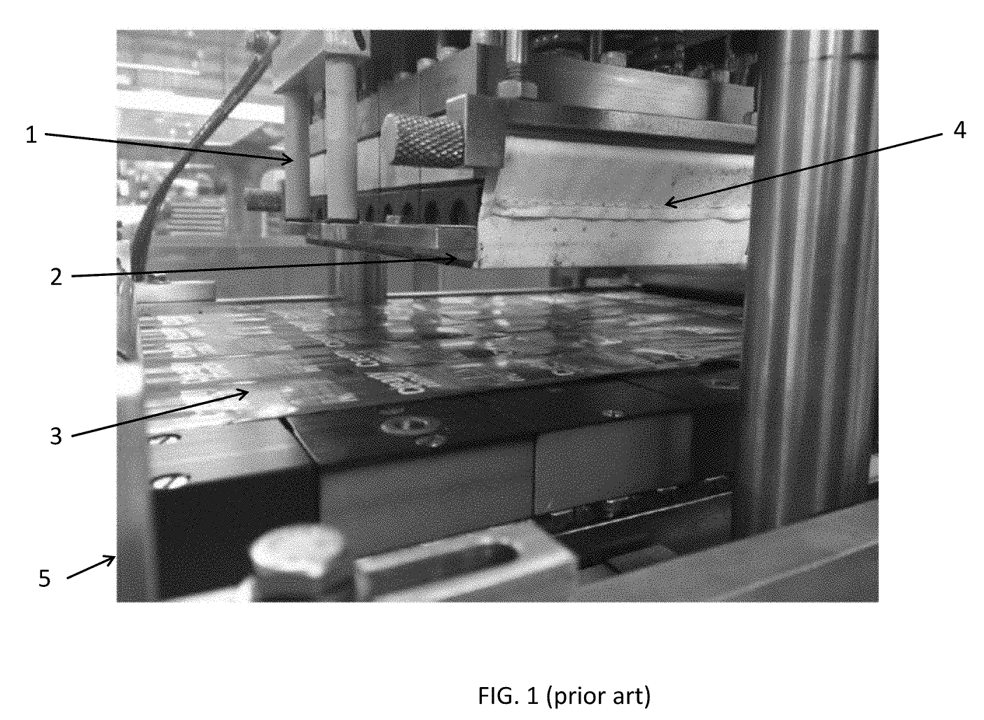

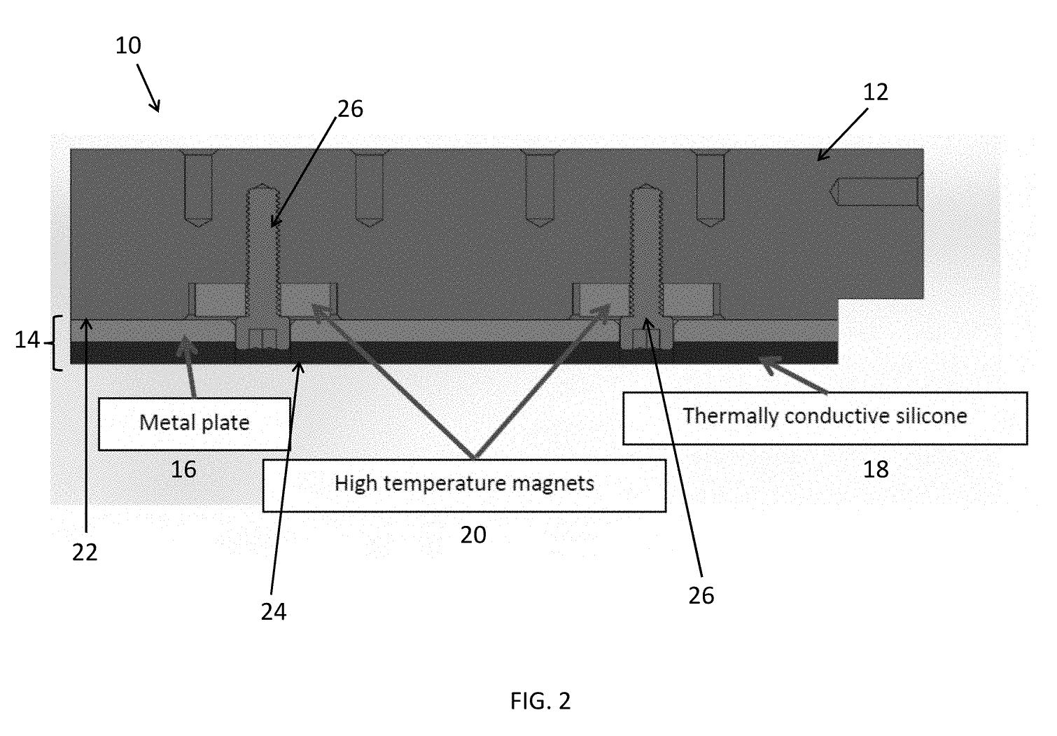

Referring now to the figures, wherein like reference numerals refer to like parts throughout, FIG. 2 depicts a side schematic representation of a sealing system 10 for heat sealing plastic packaging. In particular, FIG. 2 shows an illustrative embodiment of a sealing system 10 used to apply pressure and heat to a lid or other cover over a plastic package, such as a condiment cup or other food packaging. As shown, the sealing system 10 includes a heater block 12 attached to a silicone shoe 14. The silicone shoe 14 comprises a metal plate 16 coated with or otherwise attached to a layer of silicone 18. The heater block 12 may be a conventional heater block 2, such as that shown in FIG. 1. The heater block 12 is retrofitted or otherwise outfitted with a coupling mechanism 20, which is used to removably secure the silicone shoe 14 to the heater block 12.

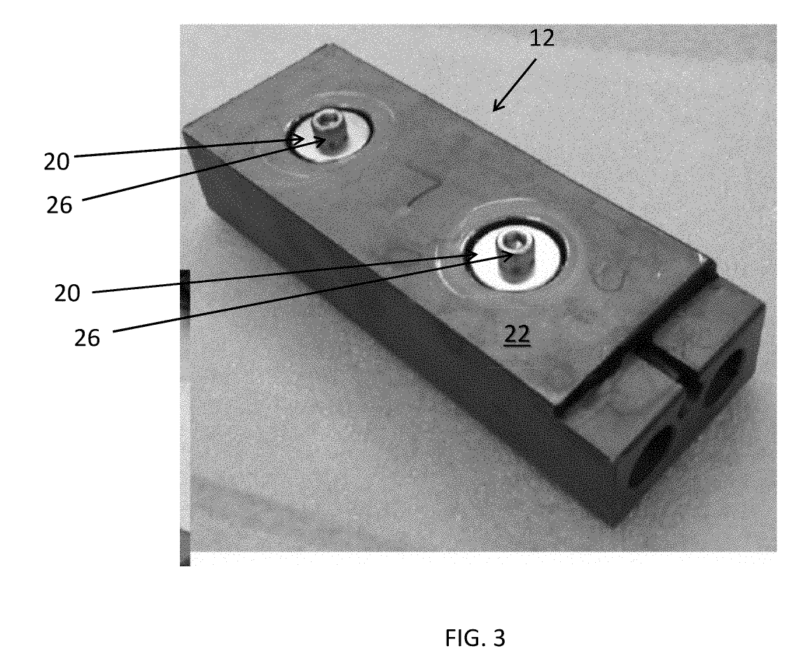

Turning to FIG. 3, there is shown a perspective view of a heater block 12 of the sealing system 10 according to an embodiment. The heater block 12 shown comprises two coupling mechanisms 20. In the depicted embodiment, the coupling mechanism 20 is a high temperature magnet. The magnets 20 are secured within the heater block 12 and extend to the bottom surface 22 of the heater block 12. In the depicted embodiment, the magnets 20 are centrally located along the bottom surface 22 of the heater block 12. The magnets 20 may be positioned at alternative locations within the heater block 12. However, if the magnets 20 are located at or near the perimeter of the heater block 12, the magnets 20 may interfere with the balanced and uniform pressure exerted across the sealing surface 24.

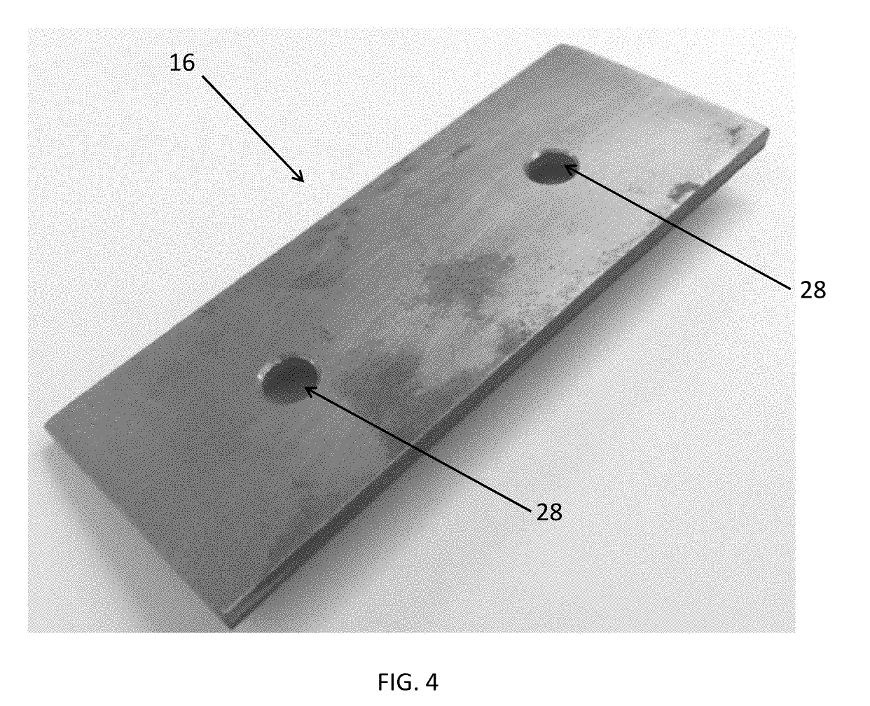

Referring now to FIG. 4, there is shown a perspective view of the metal plate 16 of the silicone shoe 14. The metal plate 16 is a ferritic metal plate 16 with high thermal conductivity to deliver energy through the silicone layer 18 to the sealing surface 24. The metal plate 16 may be composed of any ferrous metals. The metal plate 16 is attached to the heater block 12 via the coupling mechanism 20. In the embodiments shown in FIGS. 2 through 4, the metal plate 16 is removably and magnetically attached to the heater block 12. The magnets 20 in the heater block 12 attract the metal plate 16 and hold the metal plate 16 in place against the bottom surface 22 of the heater block 12.

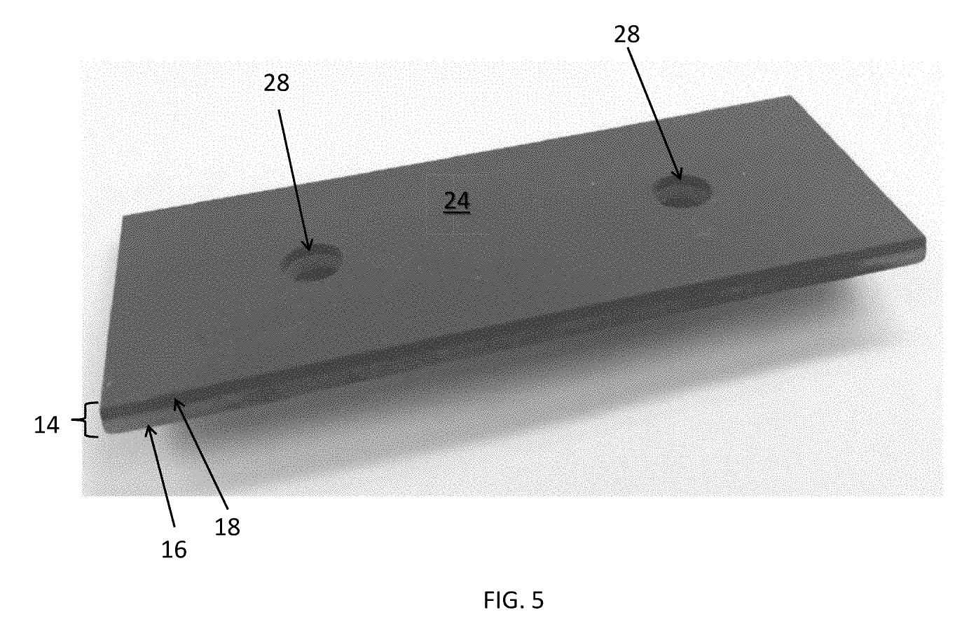

Turning to FIG. 5, there is shown the silicone layer 18 on the metal plate 16 of the silicone shoe 14. As shown, the metal plate 16 is coated with or otherwise attached to a layer of silicone 18. The silicone layer 18 is thermally conductive due to its mineral-loaded composition. In some embodiments, the silicone layer 18 may be comprised of Thermo-sil™, although other mineral-loaded silicone materials may also be used as the silicone layer 18. The minerals are added to the silicone to provide thermal conductivity throughout the silicone layer 18. In particular, the thermal conductivity of the mineral-loaded silicone layer may be substantially equal to or greater than 0.25 W/m·K, or equal to or greater than 0.5 W/m·K. Mineral-loaded silicone will typically improve greater than two times improvement in thermal conductivity versus existing materials. Therefore, heat can be more efficiently transferred through a silicone layer 18 loaded with minerals than a pure silicone pad or layer. The more efficient heat transfer obtained from the mineral-loaded silicone layer 18 allows for a sealing assembly 1 to be set at a temperature customarily required to deliver the target temperature to the sealing surface 24.

The amount of minerals loaded in the silicone layer 18 affects the hardness of the silicone layer 18, as measured on the durometer scale. The durometer of the silicone layer 18 may be as soft as 20 to 30 or as hard as 100. The silicone layer 18 should be resilient to withstand repetitive compression cycles during the sealing process in order to seal the containers in a continuous production mode. Typical sealing cycles ranges from 30 to 70 cycles per minute. The typical force of the sealing cycle can be subjected to forces of 500 to 1000 lb_{f} of compression per heater block. In an optimal sealing embodiment, the silicone layer 18 has a durometer within the range of 50 to 80. As the addition of minerals to silicone results in a silicone layer 18 that is hard and somewhat brittle, the silicone layer 18 cannot withstand stretching. Therefore, the mineral-filled silicone layer 18 cannot be used in a conventional fashion as a fabric coated pad 4 (shown in FIG. 1).

In addition to the amount of minerals loaded in the silicone layer 18, the thickness of the silicone layer 18 also influences the rate of heat transfer through the silicone. The silicone layer 18, for example, may be as thin as 0.005 inches or as thick as 0.080 inches. Thickness of the silicone layer 18 should be selected for maximum resiliency, longevity, and heat transfer properties. An optimal thickness of the silicone layer 18, for example, may be within the range of 0.020 to 0.040 inches.

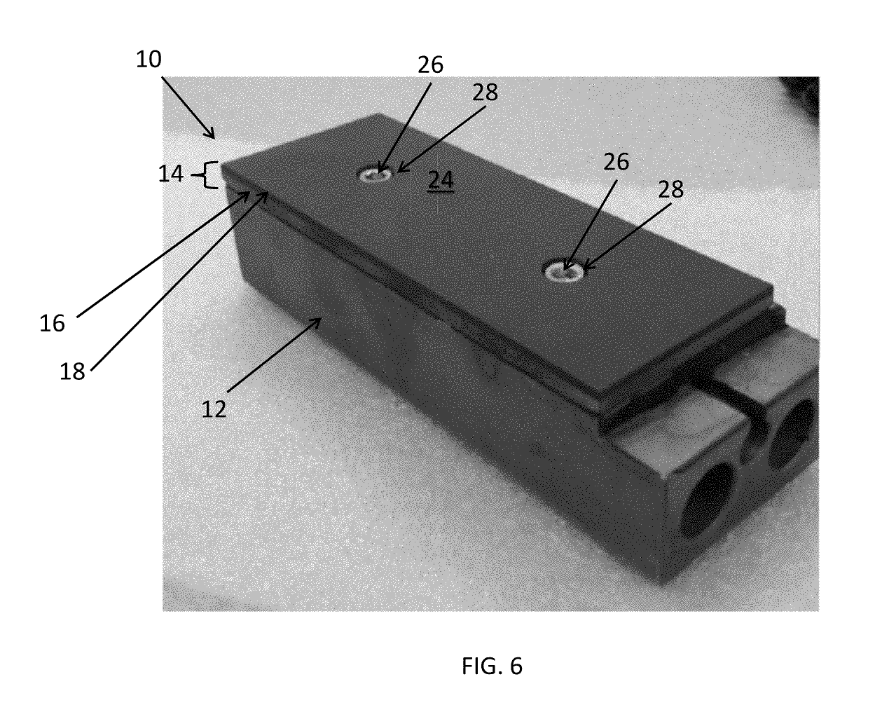

Referring now to FIG. 6, there is shown a perspective view of the sealing system 10 according to an embodiment. As shown, the sealing system 10 includes the heater block 12 magnetically coupled to a silicone shoe 14. The silicone shoe 14 includes a metal plate 16 and a silicone layer 18. In the depicted embodiment, the metal plate 16 is sandwiched between the bottom surface 22 of the heater block 12 and the silicone layer 18. In the embodiment shown in FIGS. 2 through 6, the magnets 20 are fixed within the heater block 12 with a screw or bolt 26. However, alternative known connectors 26 may be used to attach a variety of coupling mechanisms 20 to the heater block 12.

As shown in FIGS. 2 through 6, the bolts 26 lock the magnets 20 in place, which forces the metal plate 16 of the silicone shoe 14 into alignment with the heater block 12. The bolts 26 extend from the bottom surface 22 of the heater block 12, as shown in FIG. 3, and are visible to the user to facilitate alignment. When the sealing system 10 is assembled, the bolts 26 extend from the bottom surface 22 of the heater block 12 and at least partially into apertures 28 through the silicone shoe 14 (FIG. 5). Thus, the bolts 26 force the silicone shoe 14 and the heater block 12 into alignment. In an alternative embodiment, the bolts 26 are flush against the bottom surface 22 of the heater block 12, but the bolts 26 do not assist in alignment.

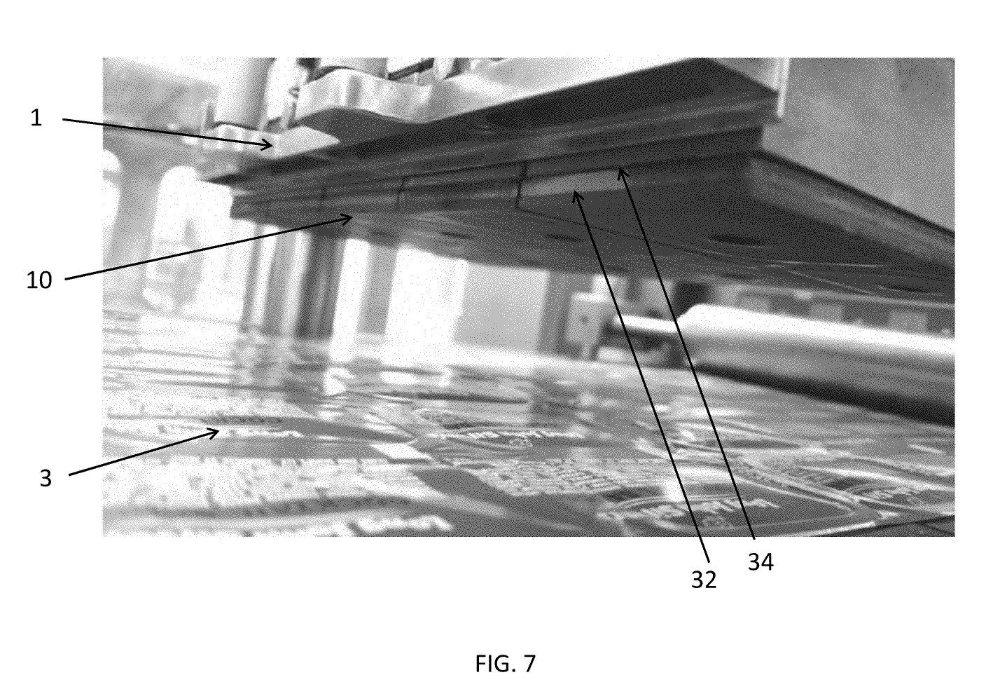

Turning now to FIG. 7, there is shown a perspective view of the sealing system 10 attached to a conventional sealing assembly 1 according to an embodiment. In the depicted embodiment, a plurality of sealing systems 10 are mounted to a conventional sealing assembly 1. A top surface of the heater block 12 is mounted to sealing assembly 1 and the sealing surface 24 on the silicone layer 18 faces in a direction toward the lids 3 over the plastic packages. Pounding force from the sealing assembly 1 pushes the attached sealing systems 10 onto lids 3 over the plastic packages. The sealing surface 24 makes contact with the lids 3 and seals the lids 3 onto the plastic packages with heat and pressure. Heat from the sealing assembly 1 passes through the heater block 12 and the silicone shoe 14 (i.e., metal plate 16 and silicone layer 18).

As stated above, because the silicone layer 18 comprises thermally conductive minerals, a sealing assembly 1 retrofitted or otherwise outfitted with the sealing system 10 may be set at a lower temperature than a conventional sealing assembly 1 using pure silicone pads 4, such as that shown in FIG. 1. Therefore, the temperature set points on the sealing assembly 1 using the sealing system 10 are the same as the heat required to seal a particular container and lid material. As a result, the lower temperature sealing broadens the scope of sealable packaging materials. Another benefit of more efficient heat transfer through the sealing system 10 is that the sealing system 10 has a lower degradation rate than the conventional silicone pads 4. Similarly, the sealing assemblies 1 outfitted with the sealing system 10 experience less wear over time as compared to those outfitted with conventional silicone pads 4.

The sealing system 10 will eventually require replacement of the silicone layer 18. At such time, the silicone shoe 14 may be easily removed from the heater block 12. The magnetic force holding the metal plate 16 of the silicone shoe 14 to the magnets 20 in the heater block 12 can be broken by simply pulling the silicone shoe 14 (i.e., metal plate 16) away from the heater block 12. A new metal plate 16 coated with a silicone layer 18 may be immediately attached to the same heater block 12. Thus, the time required to replace the silicone layer 18 is dramatically reduced as compared to the time required to replace a silicone pad 4 wrapped around the heater blocks 2 of a conventional sealing assembly 1 (shown in FIG. 1). As an additional advantage, the sealing system 10 is cost-effective as it can be incorporated into existing and conventional heater blocks 2, such as those shown in FIG. 1.

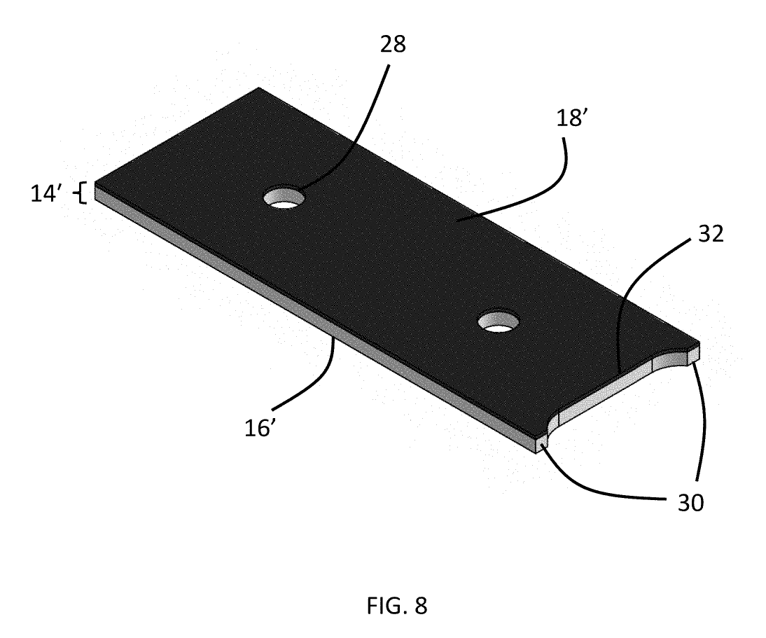

To facilitate removal of the silicone shoe 14 from the heater block 12, an embodiment of the sealing system 10 comprises tabs 30. The alternative embodiment of the silicone shoe 14′ is shown in FIG. 8. In the depicted embodiment, the silicone layer 18′ and the metal plate 16′ comprise one or more tabs 30. The tabs 30 extend from an edge 32 of the silicone shoe 14′ to provide one or more prying (or removal) locations to separate the silicone shoe 14′ from the heater block 12 (FIG. 2). In use, the silicone shoe 14′ is attached to the heater block 12 such that the tabs 30 extend outward from the heater block 12. With the tabs 30 extending out from the heater block 12, the user can press downward or otherwise apply pressure to the tabs 30, easily separating and removing the silicone shoe 14′ from the heater block 12. The tabs 30 can be manipulated by hand or with a tool, such as a screwdriver. The tabs 30 additionally aid in mounting one or more sealing systems 10 to the sealing assembly 1. The edge 32 of the silicone shoe 14′ (of the sealing system 10) aligns with an edge 34 of the sealing assembly 1, as shown in FIG. 7. Thus, the sealing systems 10 are aligned with the sealing assembly 1 when the edges 32, 34 are aligned and the tabs 30 extend outward from the sealing assembly 1.

All definitions, as defined and used herein, should be understood to control over dictionary definitions, definitions in documents incorporated by reference, and/or ordinary meanings of the defined terms.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as, “has” and “having”), “include” (and any form of include, such as “includes” and “including”), and “contain” (any form of contain, such as “contains” and “containing”) are open-ended linking verbs. As a result, a method or device that “comprises”, “has”, “includes” or “contains” one or more steps or elements. Likewise, a step of method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts and equivalents of all means or step plus function elements in the claims below, if any, are intended to include any structure, material or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the present invention for various embodiments with various modifications as are suited to the particular use contemplated.

What is claimed is:

1. A sealing system, comprising:
a heater block having at least one coupling mechanism; and
a silicone shoe removably attached to the heater block via the coupling mechanism, the silicone shoe having a metal plate bonded with a mineral-loaded silicone layer, wherein the thermal conductivity of the mineral-loaded silicone layer is substantially equal to or greater than 0.25 W/mK.

2. The system of claim 1, wherein the at least one coupling mechanism is a magnet.

3. The system of claim 2, wherein the metal plate is magnetically attracted to the magnet.

4. The system of claim 1, wherein the at least one coupling mechanism is centrally located along a bottom surface of the heater block.

5. The system of claim 1, wherein the mineral-filled silicone layer is a sealing surface.

6. The system of claim 1, wherein metal plate is composed of a ferrous metal.

7. The system of claim 1, further comprising one or more tabs extending from an edge of the silicone shoe.

8. The system of claim 1, wherein the durometer of the mineral-loaded silicone layer is within the range of 40 to 90.

9. The system of claim 1, wherein a thickness of the mineral-loaded silicone layer is within the range of 0.010 to 0.080 inches.

10. The system of claim 1, further comprising a connector attaching the coupling mechanism to the heat block.

11. The system of claim 10, wherein the connector extends outward from and beyond the bottom surface of the heater block.

12. The system of claim 10, wherein the connector extends at least partially into an aperture in the silicone shoe when the heater block is attached to the silicone shoe.

13. The system of claim 10, wherein the connector is a bolt.

14. A method for sealing a container, comprising the steps of:
providing a sealing system having a heater block with at least one coupling mechanism and a silicone shoe removably attached to the heater block via the coupling mechanism, the silicone shoe having a metal plate bonded with a mineral-loaded silicone layer, wherein the mineral-loaded silicone layer is a sealing surface, and wherein the thermal conductivity of the mineral-loaded silicone layer is substantially equal to or greater than 0.25 W/mK;
mounting the heater block to a sealing assembly such that the mineral-loaded silicone layer is positioned above a lid over the container;
heating the mineral-loaded silicone layer; and
forcing the mineral-loaded silicone layer onto the lid over the container.

15. The method of claim 14, further comprising the steps of:
retracting the mineral-loaded silicone layer from the lid; and
removing the silicone shoe from the heater block.

16. The method of claim 15, wherein the step of removing the silicone shoe from the heater block comprises the step of applying pressure to one or more tabs extending from an edge of the silicone shoe.
